(19) United States
(12) Patent Application Publication
(10) Pub. No.: US 2023/0323647 A1
(43) Pub. Date: Oct. 12, 2023

(54) Insert

(71) Applicant: Marko TAFERNER, Wölfnitz (AT)

(72) Inventor: Marko TAFERNER, Wölfnitz (AT)

(21) Appl. No.: 18/154,453

(22) Filed: Jan. 13, 2023

(30) Foreign Application Priority Data
Apr. 7, 2022 (AT) A 50223/2022

(51) Int. Cl. E03C 1/292; E03C 1/298

(52) U.S. Cl. CPC E03C 1/292; E03C 1/298

(57) ABSTRACT

An insert, which can be installed as an odor stopper in the drain area of a household installation, e.g., in a drain pipe, includes a cylindrical area, which has a flange that projects outward. The insert also includes a closure area with an elastically deformable wall part. In the closure position, the wall part of the closure area rests against an opposite wall of the insert. In this case, the free edge of the wall part rests against the opposite wall from inside, creating an odor stopper. When water flows through the drain pipe, the wall part of the closure area is moved away from the opposite wall by the draining water, so that the closure area is opened. As soon as no more water flows through the insert, the wall part of the closure area again rests against the opposite wall, so that the odor stopper is created.

### BACKGROUND OF THE INVENTION

### Field of the Invention

The invention relates to an insert that is designed as an odor stopper in the drain area of household installations, in particular its drain pipes.

### Description of the Related Art

Drain areas of household installations, for example drain pipes of wash basins, bathtubs, kitchen sinks, or the like, in general comprise a trap, which is designed as, for example, a J-trap. Water collects in the trap, which forms an odor stopper, so that odors that develop in downstream areas of the drain pipe and in a sewer into which the drain pipe empties cannot exit through the opening of the drain pipe into the wash basin, the bathtub, the kitchen sink, or the like.

When drain pipes are not used for an extended period of time, the water that is contained in the trap evaporates and the odor stopper no longer works.

Known from U.S. Pat. No. 4,870,992 A is a non-return valve that can be installed in a drain pipe. The valve has a flexibly deformable stopper part that allows the passage of liquid, but prevents the passage of gases in the opposite direction. The deformable stopper part connects directly to a flange of the non-return valve, which allows the installation of the valve in a drain pipe. The flange is clamped between parts of the drain pipe, which results in disadvantageous deformations of the valve.

Similar non-return valves are shown and described in WO 2020/130807 A1 and US D924378 S.

### SUMMARY OF THE INVENTION

The object of the invention is to make available an insert that prevents odors from exiting from the drain pipe, in particular of a household installation, even when there is no longer any water in the trap.

This object is achieved according to the invention with an insert that has the features disclosed and claimed.

Preferred and advantageous configurations of the insert according to the invention are further disclosed.

Since the insert according to the invention comprises an essentially cylindrical area, it can easily be installed in a drain pipe, in particular in the end of the drain pipe, which is connected to a wash basin, a bathtub, a kitchen sink, or the like.

Thanks to the closure area provided in the insert, the drain pipe is closed as long as no water flows through the drain pipe. Only when water flows through the drain pipe is the closure area opened by the pressure of the draining water, so that the draining of water via the drain pipe is not impeded.

It is preferred within the framework of the invention when it is provided that the essentially cylindrical area on its end opposite to the closure area has a flange that points outward.

This embodiment makes it possible to install the insert according to the invention instead of the usually employed seal that is provided between the drain fitting and the actual drain pipe. The insert according to the invention is then held by the cap nut that is common per se, which cap nut connects the drain pipe to the drain fitting.

The cylindrical area, which in a preferred embodiment of the insert according to the invention is provided between the flange that points outward and the closure area of the insert, has the advantageous effect that deformations of the insert according to the invention, in particular of its closure area, which are disadvantageous because they impair the function of the closure area, are prevented. This is true since deformations that can arise when the insert is clamped in a drain pipe via its flange occur exclusively in the cylindrical area. This is true even when the flange is strongly clamped and is thus deformed.

In a preferred embodiment of the invention, it can be provided that the closure area comprises a wall part that, with a closed closure area, rests against an opposite wall of the insert from inside.

In this case, in a further development, it is preferred that the wall part of the closure area in the closed position has essentially the shape of a part of a cone envelope. In this case, the cone envelope can be preferably oriented in such a way that its generatrix, which is adjacent to the insert wall against which the wall part of the closure area rests in the closure position, comprises an acute angle with the wall.

Within the framework of the invention, consideration is given to an embodiment in which the entire insert consists of rubber-elastic material, although it is acceptable in principle for only the wall part of the insert, which forms the closure area, to be made of elastic, in particular rubber-elastic, material.

In particular, when it is provided according to the invention that the free edge of the wall part of the closure area in an odor-impermeable manner rests against the opposite wall, in particular the free edge of the wall, a spatially advantageous arrangement is produced, which makes it possible to incorporate the insert even in drain pipes into which empties an attachment for the connector of a drain pipe of a dishwasher or the like. In this embodiment, the waste water that originates from the dishwasher or the like flows past outside the wall part of the closure area.

### BRIEF DESCRIPTION OF THE DRAWINGS

Additional details and features of the invention are given in the description below of an embodiment of the insert according to the invention with reference to the exemplary drawings. Here:

FIG. 1 shows an insert in side view,

FIG. 2 shows the top view of the insert of FIG. 1 in FIG. 1,

FIG. 3 shows the bottom view of the insert of FIG. 1 in FIG. 1,

FIG. 4 shows a section along the line Iv-Iv of FIG. 2,

FIG. 5 shows the insert of FIG. 1 in oblique view,

FIG. 6 shows a first example of installation of an insert, and

FIG. 7 shows a second example of installation of an insert.

### DESCRIPTION OF THE PREFERRED EMBODIMENTS

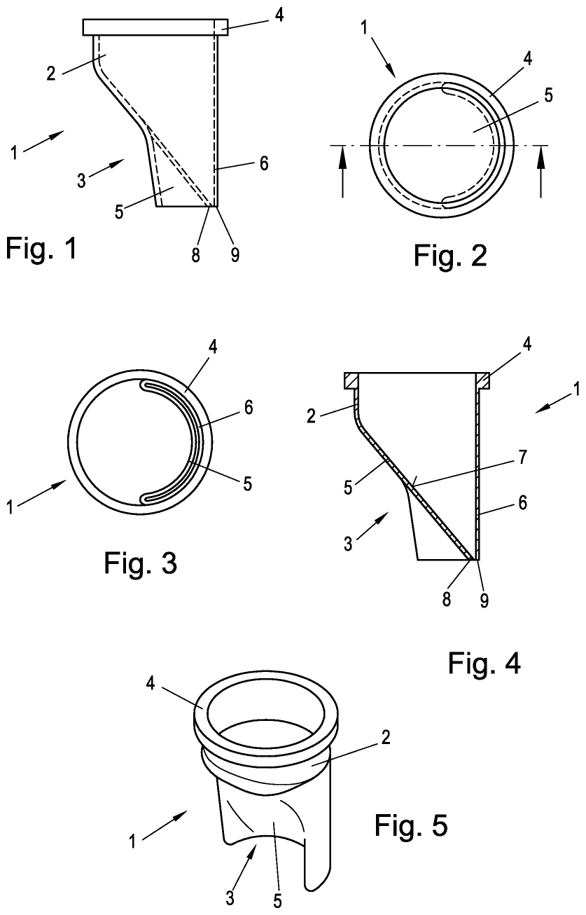

An insert 1 comprises an area 2, circular-cylindrical in the embodiment, and a closure area 3. On the upper end of the insert 1 in FIG. 1, an annular flange 4 that projects outward is provided.

The closure area 3 of the insert 1 comprises a wall part 5 that in the closure position shown in FIGS. 1 to 5 rests against the wall 6 that is opposite to it.

The wall part 5 of the closure area 3 has essentially the shape of a part of a cone envelope, wherein the generatrix 7, lying closest to the wall 6, of the cone envelope comprises an acute angle with the wall 6.

In particular, it can be seen from FIGS. 3 and 4 that the free edge 8 of the wall part 5 of the closure area 3 rests against the free edge 9 of the wall 6. This means that in the closure position, which is shown in FIGS. 1 and 4, an odor stopper is created.

It should again be pointed out that both the wall part 5 of the closure area 3 and the wall 6 of the insert 1 that is opposite to the wall part 5 are extensions of the circular-cylindrical area 2 of the insert 1.

Within the framework of the invention, it is preferred when the entire insert 1 consists of rubber-elastic material. In particular, rubber-elastic plastics, such as ethylene propylene diene (monomer) rubber (EPDM), are considered.

This embodiment of the insert 1 produces the desired action since the wall part 5 of the closure area 3 is opened under the action of water that flows through the insert 1 into a drain pipe by the wall part 5 of the closure area 3 being raised from the opposite wall 6.

In the closure position, i.e., when the closure area 3 is closed, the free edge 8 of the wall part 5 of the closure area 3 is curved in the shape of an arc of a circle just as is the free edge 9 of the opposite wall 6 of the insert 1. This shows in particular the view of the insert 1 according to FIG. 3.

The insert 1 according to the invention can—starting from an essentially circular-cylindrical molded part—be defined in such a way that the part of the wall of the molded part is deformed far enough inward that the free edge 8 of the wall part 5 rests against the opposite free edge 9 of the wall 6 that is not deformed (see FIG. 3).

Since at least the wall part 5 of the closure area 3 consists of elastic material, it is deformed by water, which flows through the insert 1, in such a way that the closure area 3 is opened. When a closure area 3 is open, the wall part 5 does not rest against the opposite wall 6, so that there is a through opening in the insert 1. As soon as water no longer flows through the insert 1, the wall part 5 is moved back again, and the closure area 3 is located in the closure position again and forms the odor stopper. This is true because under elastic rebounding of the wall part 5, the free edge 8 of the wall part 5 again becomes adjacent to the opposite wall 6, in particular to the free edge 9 of the wall 6.

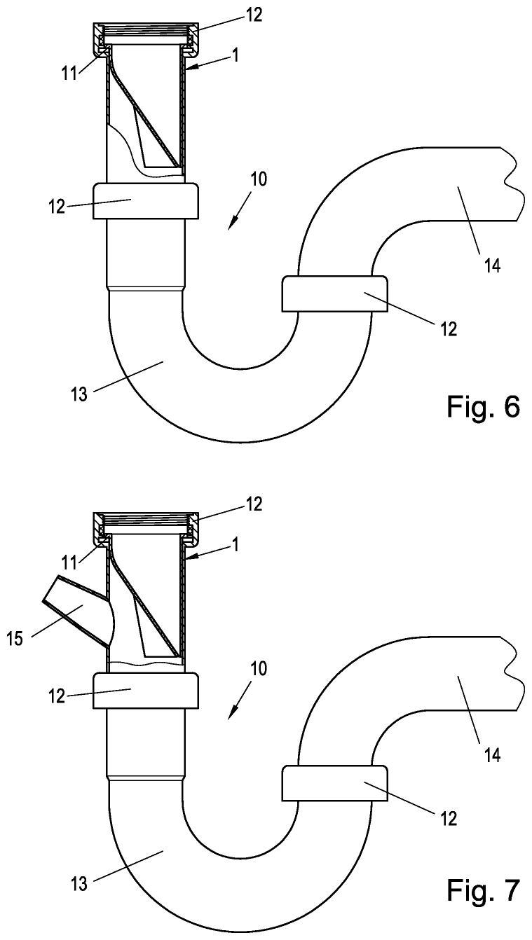

FIG. 6 depicts an example of installation of an insert 1 in a drain pipe 10, which is formed by a drain fixture. It is evident that the insert 1 with its flange 4 rests on a terminal ring flange 11 and, instead of the seal, otherwise provided there, of a cap nut 12 against a drain fitting (not shown), it is held in a sealing manner.

The area of the drain pipe 10, in which the insert 1 is arranged, overflows into a J-trap 13, which is fastened by cap nuts 12, wherein an outlet pipe 14 connects to the J-trap 13.

As shown in FIG. 7, because of the special shape of the insert 1 according to the invention and because of the described configuration of the closure area 3, the possibility is created of using the insert 1 in a drain fixture for a coil with inlet connection 15 for a dishwasher or the like, since because of the special shape of the closure area 3, the flowing of water from the inlet connection 15 is not impeded.

FIGS. 6 and 7 show that the flange 4 of the insert 1, when the insert 1 is installed in a drain pipe 10, sits between the terminal ring flange 11 and the cap nut 12. Deformations of the insert 1, which the ring flange 11 and the cap nut 12 exert on the flange 4 under great pressure and which can occur when the cap nut 12 is tightened, remain limited to the cylindrical area 2 of the insert 1. Thus, the function of the closure area 3 of the insert 1 is then not disadvantageously affected even when the flange 4 of the insert 1 that is installed in a drain pipe 10 is deformed by clamping forces.

In summary, an embodiment of the invention can be described as follows:

An insert 1, which can be installed as an odor stopper in the drain area of a household installation, for example in a drain pipe, comprises a cylindrical area 2, which has a flange 4 that projects outward. The insert 1 also comprises a closure area 3, which comprises an elastically deformable wall part 5. In the closure position, the wall part 5 of the closure area 3 rests against an opposite wall 6 of the insert 1. In this case, the free edge 8 of the wall part 5 rests against the opposite wall 6 from inside, so that an odor stopper is created. When water flows through the drain pipe, the wall part 5 of the closure area 3 is moved away from the opposite wall 6 by the draining water, so that the closure area 3 is opened. As soon as no more water flows through the insert 1, the wall part 5 of the closure area 3 again rests against the opposite wall 6, so that the

1. Insert as an odor stopper in the drain area of household installations, in wherein the insert comprises an essentially cylindrical area and a closure area, wherein the closure area is closed and can be opened by water, which flows through the insert.

2. The insert according to claim 1, wherein the essentially cylindrical area has a flange that projects outward on an end opposite to the closure area.

3. The insert according to claim 1, wherein the closure area comprises a wall part, which when the closure area is closed rests against an opposite wall of the insert from inside.

4. The insert according to claim 3, wherein the wall, against which the wall part rests, is an extension of the cylindrical area.

5. The insert according to claim 4, wherein the wall has the shape of a part of the jacket of a circular cylinder.

6. The insert according to claim 3, wherein the wall part of the closure area is an extension of the cylindrical area.

7. The insert according to claim 3, wherein at least the wall part of the closure area of the insert consists of elastic material.

8. The insert according to claim 3, wherein the wall part of the closure area with its free edge in an odor-impermeable manner rests against the opposite wall.

9. The insert according to claim 8, wherein the free edge of the wall part of the closure area is curved in the shape of an arc.

10. The insert according to claim 3, wherein the wall part of the closure area in the closure position of the closure area has essentially the shape of a part of a cone envelope.

11. The insert according to claim 10, wherein the generatrix, lying closest to the wall, of the cone envelope comprises an acute angle with the wall.

12. The insert of claim 7, wherein the elastic material is a rubber elastic material.

13. The insert of claim 12, wherein the elastic material is plastic.

14. The insert of claim 13, wherein the elastic material is ethylene propylene diene (monomer) rubber.

15. The insert of claim 8, wherein the wall part of the closure area with its free edge in an odor-impermeable manner rests against the free edge of the opposite wall.

16. The insert of claim 9, wherein the free edge of the wall part of the closure area is curved in the shape of an arc of a circle.

17. The insert according to claim 2, wherein the closure area comprises a wall part, which when the closure area is closed rests against an opposite wall of the insert from inside.

18. The insert according to claim 4, wherein the wall part of the closure area is an extension of the cylindrical area.

19. The insert according to claim 5, wherein the wall part of the closure area is an extension of the cylindrical area.

20. The insert according to claim 4, wherein at least the wall part of the closure area of the insert consists of elastic material.
